(19) United States
(12) Patent Application Publication
(10) Pub. No.: US 2005/0278238 A1
(43) Pub. Date: Dec. 15, 2005

(54) Method of and system for collecting product and related information via a network and placing this information in a persistent data store for later distribution to resellers over a network

(76) Inventor: Bruce J. Brown, Fremont, CA (US)

Correspondence Address: DKW LAW GROUP, P.C., 58TH FLOOR - USX TOWER, 600 GRANT STREET, PITTSBURGH, PA, 15219, US

(21) Appl. No.: 11/149,081

(22) Filed: Jun. 9, 2005

Related U.S. Application Data
(60) Provisional application No. 60/578,164, filed on Jun. 9, 2004.

(51) Int. Cl. G06F 17/60

(52) U.S. Cl. 705/35

(57) ABSTRACT

Disclosed is a system and method that collects information from suppliers/distributors into a relational database on one or more servers and delivers that information to resellers/distributors. The present invention resides upon one or more computer servers hosting a web server for user interface and/or an application server for business logic and/or a database server for persistent storage. A supplier introduces product and supplier information consisting of text, digitized images, digitized audio or similar multimedia formats into the system using an Internet browser or a web services client. Resellers use an Internet browser or web services client to retrieve supplier information. The suppliers may define product groups and reseller groups in order to efficiently manage its products and resellers. The supplier may define distribution rules to limit to which resellers specific product information is available.

### CROSS-REFERENCE TO RELATED APPLICATION

This application claims the benefit of U.S. Provisional Patent Application Ser. No. 60/578,164, filed Jun. 9, 2004.

### BACKGROUND OF THE PRESENT INVENTION

1. Field of the Present Invention

The present invention relates to systems and methods of collecting data from suppliers in a central server for secure distribution to resellers, and more particularly, to collecting product, supplier and related information via a network, such as the Internet, and placing this information in a persistent data store for later distribution to resellers over the network.

2. Description of Related Art

Manufacturers, distributors, wholesalers and other suppliers (collectively referred to herein as suppliers) of goods and services that are sold by other entities, such as retailers, distributors and online merchants (collectively referred to herein as resellers), need to exchange information regarding available products and services. Examples of product information include descriptions, specifications, attributes (i.e., colors or sizes), stock keeping units (SKU), lot sizes, prices, images (pictures), product availability and shipping. Each relationship between distributors and resellers may be a unique arrangement regarding products and/or pricing arrangements. There may also be special product or price offerings that are restricted in time or by group.

As used herein, a distributor is an entity that functions as both a supplier and a reseller. As such, “supplier” includes supplier and distributor and “reseller” includes reseller and distributor, whether or not specifically identified throughout.

Communicating product availability and pricing is a chronic problem as new products are introduced and old products are discontinued or otherwise become unavailable. Special promotions or reseller incentives are another urgent communication issue since these events are frequently time-sensitive and duration-limited. In today's environment, online retailers frequently are not notified of special promotions and incentives, and even when they are, often lack the time to make appropriate changes to their website(s) and advertising campaigns and/or receive the information too late.

Contemporary relationships between distributors and resellers are manual, labor-intensive and error-prone processes in which suppliers provide product information and resellers must tailor this information for their own needs. Current information delivery mechanisms include FAX, postal mail, electronic mail, electronic file transfer, manually copying information from the supplier's web site or telephone calls from sales representatives. Resellers must frequently create product information because suitable information is unavailable or is not available in a suitable format, for example, a picture from a document cannot readily be employed on a web site.

It is standard industry practice for any given supplier or reseller to have dozens or even thousands of relationships at any given time which keep product management a dynamic and challenging problem.

Automated solutions to date are: (1) aimed at large enterprises that create and sustain dedicated information systems as part of the relationship, (2) the use of e-commerce portal sites or (3) the use of specialized trading exchanges. Most small- to medium-sized suppliers and resellers cannot afford the expense to develop and field a dedicated information system or trading exchange.

E-commerce portals allow a supplier to create a web site that can be reused by a retailer to promote products. Product information is typically maintained by the supplier and customization options (by the reseller) are limited.

Through trading exchanges, a retailer can view products that are offered by multiple suppliers and optionally place a purchase order. However, trading exchanges do not provide product information useful for importation into the reseller's web site.

### BRIEF SUMMARY OF THE PRESENT INVENTION

The present invention is a method and system that collects and organizes product information from suppliers into a relational database on one or more servers and delivers that information to resellers. Suppliers are typically manufacturers and/or distributors of products or services. Resellers are typically e-commerce retailers and/or distributors. The present invention facilitates the exchange of pertinent information between a supplier and a reseller so they may decide to engage or not engage in a business relationship where the reseller sells the supplier's products and/or services.

The relational database acts as a central repository for information that is exchanged between suppliers and resellers and synchronized by the system. Product information is provided in a machine-readable format that can be readily imported into the reseller's web site. The reseller is then free to customize or alter the information as desired.

Security features may also be included to assure proper handling of information. Many methods of pricing products and limiting availability may also be provided.

Thus, the present invention provides improved distribution and synchronization of information by way of a central persistent data store that contains product information from suppliers and distributes this product information to resellers.

### BRIEF DESCRIPTION OF THE DRAWING

FIG. 1 is a deployment diagram showing the relationship between supplier, reseller and web servers.

### DETAILED DESCRIPTION OF THE PRESENT INVENTION

The present invention collects and organizes information from suppliers into a database and delivers that information to resellers. Information includes information regarding products, services, and/or the associated entity.

The present invention resides upon one or more computer servers hosting a web server for a user interface and/or an application server for business logic and/or a database

System users assume one of four roles, an “administrative” role concerned with maintenance of the system, a “service provider role” that accesses the system, a “supplier” role that produces product information, a “reseller” role that consumes product information, and a “distributor” role that produces product information and consumes product information.

System administrators are empowered to manipulate other accounts and to inhibit system access or deny processing of products that violate terms of use. Limited access is provided to service providers, such as Federal Express, who may wish to run advertisements to suppliers and/or resellers.

The supplier is provided with a supplier client capable of running on common PC operating systems, such as Windows, Macintosh, Linux, etc. The supplier client allows easy mapping of data from flat files (tab delimited, comma separated, etc.), spreadsheets, ODBC compliant databases, etc. Data is loaded from these sources into the supplier client. The supplier is provided with a rich set of tools to validate that the data contains all required fields and to make any necessary corrections. Once completed, the supplier selects a function (or script) on the supplier client to produce an XML (Extensible Markup Language) file that is, in turn, uploaded to the server-based portion of the present invention. The server-based software once again validates the data before incorporating the new/changed product and/or promotion information into the persistent data store. While this functionality is provided as a supplier client capable of running on common PC operating systems, the same functionality may also be provided by software running on the server allowing flexible deployment of the present invention depending on the needs of the supplier.

The reseller is provided with a reseller client capable of running on common PC operating systems, such as Windows, Macintosh, Linux, etc. The reseller client accepts XML from the server-based portion of the present invention. It also accepts product and product-related information, such as categories, attributes, etc., from the reseller's existing systems and/or web site software and/or flat files. The reseller is provided with a rich set of tools to validate that the data contains all required fields and to make any necessary corrections. Once completed, the reseller selects a function (or script) on the reseller client to produce one or more flat files that are, in turn, used to update the reseller's web site. Creation and editing of both HTML and plain text are supported. While this functionality is provided as a reseller client capable of running on common PC operating systems, the same functionality may also be provided by software running on the server allowing flexible deployment of the present invention depending on the needs of the reseller.

The distributor has the functionality of both a supplier and a reseller. As such, the functionality described herein for the supplier and the reseller applies to the distributor, whether or not specifically indicated. The distributor may be provided with the supplier client and the reseller client, or may be provided with a distributor client that combines the supplier and reseller clients.

Four states of information are preferably maintained: 1) a last version of the information provided by the supplier, 2) a current version of the information provided by the supplier, 3) a last version of the information the reseller used to update their web site and 4) a version the reseller is currently considering and modifying in preparation for loading on the web site. Differences between the last and current version of the supplier's information may be highlighted. The reseller client allows the reseller to quickly find all supplier records that have changed and make appropriate changes to his/her own store. Global preferences, as well as preferences for the way data from each supplier are handled, are supported. For instance, the reseller may indicate that he wants to take product descriptions “as is” from all suppliers, but override that decision on one or more selected suppliers. Similarly, the reseller can establish pricing rules (markup/markdown based on price or cost provided by the supplier) and set rules for the handling of unavailable or discontinued products, such as removing them from the website or putting up an appropriate message or image on the website.

Special adapters allow the present invention to interact directly with store front software. The adapters are in concert with functions provided to the reseller (described throughout) which allow real- or near-real time update of the reseller's web-based store when changes or additions are provided by associated supplier(s).

Suppliers and resellers connect to the system via the Internet using web browsers or allow their systems to connect through a SOAP (Simple Object Access Protocol) interface. System access is negotiated and must be approved prior to use. All users are given unique, individual accounts that specify data ownership and are associated with the primary role of “administrative,” “service provider,” “supplier” or “reseller.” The role determines the type of operations which will be permitted within the system as well as the accessibility and editing of individual screens and fields. Multiple users are allowed from a given supplier or reseller allowing the supplier or reseller the ability to delegate various pieces of work to selected individuals, each of whom have limited access to the system.

A reseller is enabled to accept product information from zero to many suppliers. A reseller petitions (and is accepted by) a supplier. A reseller may request termination from a supplier at any time.

The supplier may post questions that will be presented to resellers wishing to carry the supplier's products. The reseller answers those questions from within the present invention, and the answers are presented to the supplier for review. The supplier is given the ability to approve or disapprove the reseller, and notification is sent through a secured communication mechanism within the present invention.

Messages queues are maintained for system-generated messages, such as notifications to resellers that products have changed availability or pricing, general communication, such as replies from suppliers to resellers about their requests to sell the supplier's products, and promotional/advertising messages.

From the reseller point of view, each supplier appears as a separate queue with a brief summary of update activity (i.e., quantity of updates pending and most recent refresh). Fresh updates from a supplier may generate an alert in the form of email, pager notification, instant message, FAX or similar mechanism, which assists the reseller in being aware of new information.

A reseller may request a download of new information in the form of an XML file via a browser. Image, audio or other media files will be referenced in the XML file as a URL, which permits their downloading, or may be provided in a compressed format, such as a zip file. If the reseller is satisfied with the download, they can commit the update which marks the fresh product information as delivered and clears the inbound queue. A reseller is free to download all products or any subset, although incremental delivery should be the norm.

Alternatively, a reseller may have a SOAP client that can directly request the

A supplier employs the present invention to define product information. Examples of product information include descriptions or specifications, attributes (i.e., colors or sizes), stock keeping units (SKU), Universal Product Codes (UPC), lot sizes, prices, currencies, digitized images, digitized audio or similar multimedia formats and shipment details. Product information is distributed to resellers based upon product group and reseller group rules. Prices are generated according to product information or potentially modified by reseller or product group rules. Product text may be stored and retrieved in multiple languages (i.e., English, Japanese, etc.).

A supplier may update product information at any time. Additionally, a supplier may also specify temporary conditions, such as “out of stock,” or permanently discontinue an item.

A supplier may have zero to many resellers. It is incumbent upon a supplier to implicitly accept a reseller and a supplier may suspend or revoke a reseller at any time.

A supplier may arrange resellers into groups (“reseller groups”) and manage them as an aggregate. A reseller may be a member of zero to many reseller groups, relative to any particular supplier. Reseller groups may have temporal qualifications that can cause them to be created or expire at a particular time. Reseller groups may also have pricing rules applied exclusively to the group. Group membership information is private to the supplier and not propagated to resellers.

The present invention may support “product categories” that are employed as a navigation aid (i.e., all egg timers could reside under the timer category). A product may be associated with zero to many categories. A category may have zero to many products associated with it. All product categories are distributed to all authorized resellers and categories are stored in multiple languages (i.e., English, Japanese, etc).

Products may be arranged into groups called “product groups” to simplify management. Products may be a member of zero to many product groups, and product groups may be tied to reseller groups. Product group information is private to the supplier and not propagated to resellers.

The relationships between product groups and reseller groups create a flexible distribution mechanism under the direct control of the supplier. For example, if a supplier wishes to restrict a subset of products to a few select resellers, it is a simple matter to create a product group containing these products, a reseller group containing the select resellers and then associating the reseller group to the product group.

Another example would be a two-week promotion. A supplier could decide which products to include in the promotion and create a product group with special pricing rules (i.e., 10% off). The supplier then selects the resellers who will be authorized for the sale and creates a reseller group with the start and end times of the promotion. Finally, the supplier associates a reseller group with the product group. The system then generates a sale alert to the authorized resellers, alerting them of the impending event. When the event becomes active (based on the start time), a pricing engine will update prices and distribute new product information to the authorized resellers. When the event expires, the pricing engine will again update prices and distribute new product information to the resellers.

A supplier may select from multiple delivery mechanisms to manipulate the system, including a SOAP client or an Internet browser. Using an Internet browser, a supplier may command a file upload of either an XML file or a flat file. Within these files may be filenames of image, audio or other multimedia files that will also be retrieved using the browser.

Regardless of mechanism, this information will be parsed and validated to create a “batch” object. A batch is a unit of work and could be as trivial as updating the text of a product category or as complicated as defining thousands of products, product groups and reseller groups.

For example, a supplier might upload a batch XML file deleting several products and adding many new products. If this file parses and validates, it will be committed and authorized resellers will have access to the updated product information contained within the batch.

Another example would be a supplier interactively editing a product using the browser. When the supplier is satisfied and presses “commit,” this, in turn, generates a batch containing the recent change which is propagated to authorized resellers.

The present invention provides for secured communication between suppliers, resellers, distributors and site providers, as well as to and from system administrators.

Thus, in use, a supplier introduces product information consisting of text, digitized images, digitized audio or similar multimedia formats into the system using an Internet browser or a web services client. In addition to static product information, suppliers may also specify pricing rules for specific products and resellers, or temporary conditions, such as “out of stock.” Using distribution rules supplied by the supplier, the system determines which resellers are eligible to receive the product information and may generate an alert (alert delivery mechanisms include email, pager, instant messaging client, Internet browser, etc.) signifying that fresh product information is available.

Resellers may respond to the alert using an Internet browser or web services client to retrieve updated product information andmultimedia references. The system maintains a profile of update history, and resellers can elect to receive incremental updates (i.e., a reseller need only download the product information that has been updated since the last refresh cycle).

The present invention provides improved dissemination and synchronization of information by way of a central repository of information utilizing a relational database which stores information about suppliers, such as the supplier's application form for potential resellers, a description of their products and services, image(s) of their logo, their terms and conditions, etc., resellers, such as the resellers credit references, line of business, years in business, etc., promotions, such as the dates the promotion will be in effect, promotional pricing, supplier's criteria for allowing a reseller to participate in the promotion(s), etc., and products, such as product code, product title, product description, image(s), availability, cost to reseller, SRP (Suggested Retail Price), MSRP (Minimum Suggested Retail Price), quantity pricing, etc.

The present invention includes workflow, content management, editing tools, and validation tools to be used by people, such as copywriters, editors, photographers and managers, in reviewing, revising and approving/disapproving work. When a new assignment is created an appropriate individual may includes directions on how the work is to be done, such as writing style, number of keywords, length of the “copy”, pictures to be taken/reformatted, etc. The individual may be the requester (customer) or someone in charge of assigning work to the author, photographer or both. The present invention does real time analysis of the work as it is prepared by the writer to determine if the required style, keyword count and keyword positioning have been met. Reporting on these parameters is also available to others, such as the manager and/or the customer who requested the work. The present invention tracks the amount of time individuals spend on each item. HTML, as well as conventional editing, is supported by the present invention. All of the features are provided through a browser interface to the present invention.

It is noted that in the preceding and following details of a preferred embodiment, the protocols, language, forms, etc., are disclosed by way of example and not by limitation.

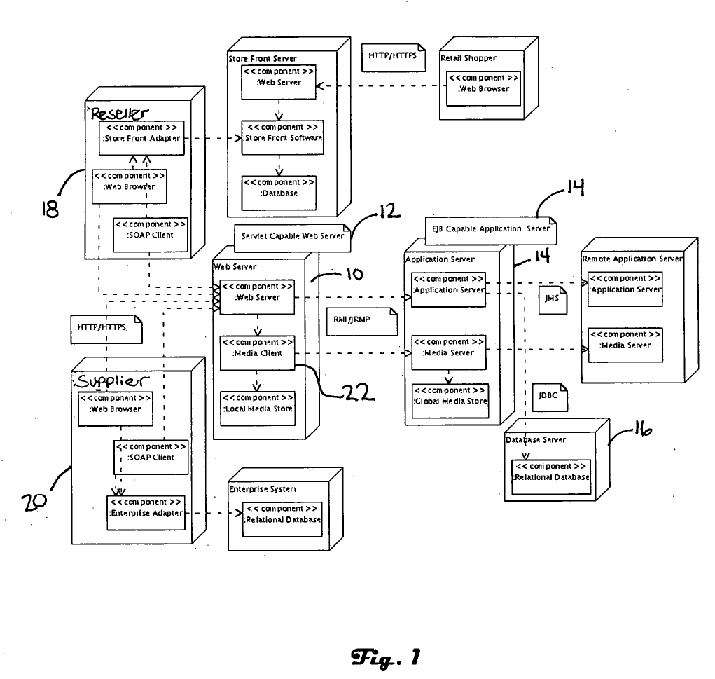

Referring to FIG. 1, for example, a web server 10 is shown running HTTPD (Hypertext Transfer Protocol daemon) that waits in attendance for requests to come in from the rest of the web.

In one embodiment of the present invention, requests may be made via an ad hoc update provided through a web browser using HTTPS (Hypertext Transfer Protocol over Secure Socket Layer). HTTPS encrypts and decrypts the ad hoc update to assure security. Ad hoc updates through a web browser to allow the supplier to easily access and update the system without the need for additional software beyond a web browser.

In another embodiment of the present invention, a request may be made via an XML (Extensible Markup Language) file update provided through a web browser using HTTPS. XML provides a flexible way to create common formats and share both the data and the form on the World Wide Web and elsewhere. XML is a widely used and understood standard which may facilitate connecting the system and method to existing systems within customer organizations, such as the customer's current order management system and website system. The present invention may provide a well-formed XML description covering the types of data that are supported and the updates that can be applied to them.

Another embodiment of the present invention provides a request via a spreadsheet file update provided through a web browser using HTTPS. The present invention may provide one or more well-formed spreadsheet template(s) covering the types of data that are supported and the updates that can be applied to them. Spreadsheets are a common way of spreadsheet software is readily available and used by most, if not all, suppliers, this manner of updating is low in cost and may simplify the supplier's work.

File upload capabilities may be provided using RFC-1867 multi-part/form data post. RFC-1867 provides a well-documented manner of form-based file uploads in HTML. Image filename references may be included as part of the information transmitted using XML.

The web server is also associated with a SOAP (Simple Object Access Protocol) client. SOAP is a way for a program running under one kind of operating system (Windows XP, for instance) to communicate with a program running under the same operating system or another operating system (Linux, for instance) by using the World Wide Web's Hypertext Transfer Protocol (http) and its Extensible Markup Language (XML) as the mechanisms for information exchange. Communication between the web server and SOAP client allows updates to occur and images to be transmitted to the web server. SOAP enables compatibility with a wide variety of clients including wireless, other applications (i.e., “machine to machine”), browsers, portals, etc.

A preferred embodiment of the present invention is implemented in Java™ using the Java 2 Enterprise Edition™ application program interface (API). System deployment is spread across multiple host machines, with one or more web servers (employing Java servlets) feeding a business logic tier (application server employing Enterprise Java Beans), which, in turn, manipulates a resource tier (hosting the RDBMS for persistent storage).

Referring again to FIG. 1, the “servlet capable web server” 12 constitutes the web tier, the “EJB capable application server” 14 represents the business tier and the “database server” 16 contains the resource tier. This diagram also illustrates the relationship between supplier and reseller hosts relative to the system.

Multiple instances of the system may be employed for scalability and robustness. Remote systems synchronize each other by sending messages via Java Messaging System (JMS).

The web tier consists of one or more web servers 10 (HTTPD in FIG. 1) which accept incoming HTTP/HTTPS(RFC-2616, et al.) requests. Depending upon the requesting URL, the request will be serviced by a SOAP handler or a Model-View-Controller (MVC) handler (for interactive browsing), both implemented as individual Java servlets. Any compliant servlet container will suffice; representative web server implementations include Jakarta Tomcat or Caucho Resin.

In general, all operations available via the browser are available via SOAP, only the delivery mechanism is different.

All users negotiate a login to the system by supplying a username and password. If access is granted, the session is tied to a primary role of “administrative,” “service provider,” “supplier” or “reseller” by means of the role that was previously assigned to the login id specified. The role determines the range of legal operations a user may perform and what information may be manipulated. A user may only manipulate information associated with their own account.

A reseller 18, for example, may perform the following functions:
Receive system status messages
Receive alerts
Manage account options (i.e., password, alert notification, default language)
Determine which suppliers have agreed to furnish product information
Determine if fresh product information is available
Request download of product information (fresh or old)

A supplier 20, for example, may perform the following functions:
Receive system status messages.
Receive alerts
Manage account options (i.e., password, alert notification, default language)
Manage resellers
   a. Accept/reject new reseller applications
   b. Suspend/terminate existing reseller applications
   c. Associate resellers to reseller groups
Manage products
   d. Create/update/delete/suspend products (text, images, audio, etc.)
   e. Associate products to product groups
Manage product categories
   f. Create/update/delete product categories
   g. Associate products to product categories
Manage product groups
   h. Create/update/delete product groups
   i. Associate product groups to products
   j. Associate product groups to reseller groups
Download the current catalog for import into local ERP system, XML file, or SOAP request

Interactive web browsing may be supported using the MVC servlet. Each update is considered a batch action and submitted to the business tier for processing.

In the case of XML or comma delimited files (specified via browser), these are retrieved using RFC-1867 extensions to HTTP. Once the file has been retrieved, it is parsed and validated. Any outstanding references to media files (images, audio, etc.) are also retrieved using RFC-1867. Successful retrieval and validation results in the creation of a “batch” object for processing by the business tier. If the business tier is successful, the batch is committed to persistent storage and a success message will be displayed to the supplier. Simultaneously, an alert message will be generated to the resellers and the updated product information will be immediately available for download.

In the case of a SOAP request, an XML message will be parsed and processed. If successfully validated, a “batch” object will be produced and submitted to the business tier for further validation. If there are no errors on the business tier, the batch will be committed to persistent storage and a result code indicating success will be returned: to the SOAP client. Simultaneously, an update alert will be issued to authorized resellers who may immediately retrieve the latest product information. Failure at any step will result in an error code being returned to the client and no update to resellers will be performed.

Media files (image, audio, etc.) are a special case. Each web server will have a dedicated servlet called “media client” 22 which manages local media storage. If a new media file is uploaded, a copy of the fresh media file is sent to the global “media server” for long term storage. When a request arrives for a specific media file, the media client will search the local store. If the request can be satisfied locally, it is returned from the local store; otherwise, a request for the media file is made of the media server. The media file is then business tier and resource tier servers are not exposed to the Internet and, therefore, cannot service such requests directly.

The “media client” periodically “ages out” images which have not been requested recently. The theory is that fresh images will be the most active requests and old images will be the least active. Caching fresher images on the web server enhances system response.

The business tier consists of a single server containing a Enterprise Java Beans™ 2.0 (“EJB”) compliant application server and a global “media server” (which is not EJB).

The media server waits for requests from “media clients” and is responsible for archiving media files. Media files have a dedicated storage and replication system optimized for large transfers.

All complicated business logic, messaging or database interaction passes through the application server. Representative application servers include BEA Weblogic, IBM Websphere, Jakarta Geronimo or JBoss.

Within the business tier, all requests arrive via RMI/JRMP.

The business tier provides the following services:
a. User validation—All users must be known to the business tier.
   i. If a user is suspended or locked out, the business tier enforces.
b. Batch validation
   i. Insert/Update/Delete of product inforation
   ii. Insert/Update/Delete of product categories
   iii. Insert/Update/Delete of media file information
   iv. Insert/Update/Delete of resellers
   v. Insert/Update/Delete of reseller groups
   vi. Reseller alerts (when information is updated)
c. Pricing Engine
   i. Different resellers may be shown different prices.
d. Synchronization Engine
   i. Resellers need only download fresh information.
e. Temporal Engine
   i. Special Events occur on time boundaries.
f. Fee Engine
   i. All system activity is metered for invoicing purposes.

For security reasons, the resource tier only communicates with the business tier. It is within this tier that the database resides.

It is understood that those skilled in the art would understand that other similar protocols, language, forms, etc., may be substituted for those disclosed herein, yet fall within the scope and spirit of the claims appended hereto.

There are other various changes and modifications which may be made to the particular embodiments of the present invention described herein, as recognized by those skilled in the art. However, such changes and modifications of the present invention may be constructed without departing from the scope of the present invention. Thus, the present invention should be limited only by the scope of the claims appended hereto, and their equivalents.

1. A computer-implemented method for collecting information from suppliers and making the information available to resellers, comprising the steps of:
providing a supplier interface to each supplier;
collecting supplier information from each supplier via the supplier interface;
organizing the supplier information in a database;
providing a reseller interface to each reseller; and
providing to each reseller access to the database via the reseller interface.

2. The computer-implemented method according to claim 1, further comprising the steps of, for each reseller:
enabling the reseller to select desired supplier information from the database; and
loading the desired supplier information into a reseller system.

3. The computer-implemented method according to claim 1, further comprising the step of, for each supplier, subsequently collecting new supplier information.

4. The computer-implemented method according to claim 1, further comprising the step of, for each supplier, enabling the supplier to create one or more reseller groups, each reseller group including at least a subset of the resellers,
wherein the supplier manages the at least a subset of the resellers as an aggregate through the reseller group.

5. The computer-implemented method according to claim 4, further comprising the step of, for each supplier, enabling the supplier to create one or more product groups, each product group including at least a subset of available products from the supplier,
wherein the supplier manages the at least a subset of the available products as an aggregate through the product group.

6. The computer-implemented method according to claim 5, further comprising the step of, for each supplier, linking the one or more reseller groups to the one or more product groups.

7. A computer-implemented system for collecting supplier data from suppliers and placing the supplier data in a data storage for later distribution to resellers, comprising:
one or more computer servers hosting a web server for user interface, an application server for business logic, and a database server for the data storage;
one or more supplier clients associated with and in data communication with the one or more computer servers for exchange of the supplier data between the one or more supplier clients and the one or more computer servers and for collection of the supplier data on the database server; and
one or more reseller clients associated with and in data communication with the one or more computer servers for exchange of the supplier data between the one or more computer servers and the one or more reseller clients.

8. The computer-implemented system according to claim 7, wherein:
the supplier data is saved into a database on the database server, and
access to the database is provided to the reseller clients.

9. The computer-implemented system according to claim 7, wherein the supplier data is synchronized by the system.

10. The computer-implemented system according to claim 7, wherein at least a portion of the supplier data from one or more supplier clients is organized into combined product information.

11. The computer-implemented system according to claim 7, wherein supplier data is exchangeable between one supplier client and one reseller client to enable the one reseller client to display and sell products of the one supplier client.

12. The computer-implemented system according to claim 7, wherein the supplier data is exchangeable between one supplier client and one reseller client to enable the one reseller client to display and sell services of the one supplier client.

13. The computer-implemented system according to claim 7, wherein, for each supplier, at least a subset of the resellers is organized into a reseller group, wherein the supplier manages the at least a subset of the resellers as an aggregate through the reseller group.

14. The computer-implemented system according to claim 13, wherein, for each supplier:
at least a portion of the supplier data is organized into a product group,
the supplier manages the at least a portion of the supplier data as an aggregate through the product group, and
the product group is associated with the reseller group.

15. The computer-implemented system according to claim 7, wherein the supplier data is refreshable.

16. The computer-implemented system according to claim 7, further including security features to assure authorized handling of information.

17. The computer-implemented system according to claim 7, further including a storefront server associated with and in data communication with the one or more reseller clients.

18. The computer-implemented system according to claim 17, further including a retail shopper associated with and in data communication with the one or more reseller clients through a web browser.

19. The computer-implemented system according to claim 7, wherein the one or more web servers include a remote application server with application server and media server capability.

20. A computer implemented system for creating and maintaining information from a supplier on a supplier/reseller communications system, comprising:
workflow tools including rules for processes to be followed;
editing tools to create content;
content management tools including management algorithms to assist in creating the content according to content requirements; and
validation tools including validation algorithms to ensure that the content meets the content requirements.
